(19) United States
(12) Patent Application Publication
(10) Pub. No.: US 2010/0020047 A1
(43) Pub. Date: Jan. 28, 2010

(54) Method of driving a plasma display panel and driver therefor

(76) Inventors: Kyung-Sub Shim, Suwon-si (KR); Hak-Cheol Yang, Suwon-si (KR); Dae-Hwan Kim, Suwon-si (KR); Seung-Yong Lee, Suwon-si (KR)

Correspondence Address: LEE & MORSE, P.C.;Attorneys and Counselors At Law, SUITE 500, 3141 FAIRVIEW PARK DRIVE, FALLS CHURCH, VA, 22042, US

(21) Appl. No.: 12/458,928

(22) Filed: Jul. 28, 2009

(30) Foreign Application Priority Data
Jul. 28, 2008 (KR) 10-2008-0073541

(51) Int. Cl. G06F 3/038

(52) U.S. Cl. 345/204; 345/60

(57) ABSTRACT

A method of driving a plasma display panel having a capacitive load formed by a plurality of scan electrodes and a plurality of address electrodes crossing the scan electrodes, using a driver including an address energy recovery circuit (AERC) that applies an address voltage to the address electrodes by an inductor electrically coupled to the address electrodes and resonance of the capacitive load, wherein, during an address period in which one of a scan signal and a non-scan signal is applied to each of the scan electrodes, the method includes applying the scan signal to a current scan electrode, and applying the scan signal to a subsequent scan electrode adjacent the current scan electrode after application of an address signal is complete, the address signal varying from a base state for a period longer than application of the address voltage.

### BACKGROUND

1. Field

Embodiments relate to a method of driving a plasma display panel and a driver therefor.

2. Description of the Related Art

A plasma display panel is a flat panel display that displays characters or images using plasma generated by a gas discharge. Plasma display panels include tens of to millions of pixels arranged in a matrix according to the size of the plasma display panel.

Scan electrodes and sustain electrodes disposed parallel to each other are formed on one surface of the plasma display panel. Address electrodes are formed on the other surface of the plasma display panel in a direction vertical to the scan electrodes and the sustain electrodes. The sustain electrodes are formed to correspond respectively to the scan electrodes and ends of the sustain electrodes are commonly coupled to each other. Discharge cells (hereinafter referred to as a “cells”) are formed at respective intersections of the scan and sustain electrodes and the address electrodes.

The plasma display panel is generally driven by a plurality of subfields, each subfield being divided into a reset period, an address period, and a sustain period. During the reset period, a state of each cell is reset in order to facilitate an addressing operation in the cells. During the address period, cells are selected to be turned on or not turned on and wall charges are accumulated in the turned-on cells (addressed cells). During the sustain period, a discharge operation to display pictures on the addressed cell may be performed.

In general, discharge spaces between the scan electrode and the sustain electrode, and between an address electrode-formed surface and a scan and sustain electrode-formed surface, function as a capacitive load (hereinafter, referred to as ‘panel capacitor’). Therefore, in order to address cells during the address period, a large amount of charge-injecting reactive power that generates a predetermined voltage in the panel capacitor is required in addition to the power for the addressing, which leads to the increase in the address power consumption.

### SUMMARY

Embodiments are therefore directed to a method for driving a plasma display panel and driver therefor, which substantially overcome one or more of the problems due to the limitations and disadvantages of the related art.

It is therefore a feature of an embodiment to provide a driving method and driver therefor that reduces a probability that a low discharge will be generated in selected cells when using an address energy recovery circuit.

It is another feature of an embodiment to provide a driving method and driver therefor that reduces power consumption.

At least one of the above and other features and advantages may be realized by providing a method of driving a plasma display panel having a capacitive load formed by a plurality of scan electrodes and a plurality of address electrodes crossing the scan electrodes, using a driver including an address energy recovery circuit (AERC) that applies an address voltage to the address electrodes by an inductor electrically coupled to the address electrodes and resonance of the capacitive load, wherein, during an address period in which one of a scan signal and a non-scan signal is applied to each of the scan electrodes, the method including applying the scan signal to a current scan electrode, and applying the scan signal to a subsequent scan electrode adjacent the current scan electrode after application of an address signal is complete, the address signal differs from a base state for a period longer than application of the address voltage.

The address signal has an LC resonance waveform before/after applying the address voltage (Va). Applying the address signal may be complete when the LC resonance waveform is completed after the application of the address voltage.

Applying the non-scan signal to the subsequent scan electrode from when the scan signal is applied to the current scan electrode to when the scan signal is applied to the subsequent scan electrode.

Applying the scan signal to the subsequent scan electrode may be delayed by a predetermined time after the non-scan signal is applied to the current scan electrode.

Applying the scan signal to the subsequent scan electrode may be concurrent with the address signal returning to the base state.

Applying the non-scan voltage to all scan electrodes while completing application of the address signal.

At least one of the above and other features and advantages may be realized by providing a driver for use with a plasma display panel having a capacitive load formed by a plurality of scan electrodes and a plurality of address electrodes crossing the scan electrodes, the driver includes an address energy recovery circuit (AERC) configured to generate an address signal including an address voltage to be applied to the address electrodes by an inductor electrically coupled to the address electrodes and resonance of the capacitive load, a period during which the address signal is different from a base state being longer than a period during which the address voltage is applied, and a scan driver configured to apply, during an address period, one of a scan signal and a non-scan signal to each of the scan electrodes, the scan driver being configured to apply the scan signal to a subsequent scan electrode when application of the address signal to a current cell is complete.

The address signal may have an LC resonance waveform before/after applying the address voltage (Va). Applying the address signal may be complete when the LC resonance waveform is completed after the application of the address voltage.

The scan driver may be configured to apply the non-scan signal to the subsequent scan electrode from when the scan signal is applied to a current scan electrode to when the scan signal is applied to the subsequent scan electrode.

The scan driver may be configured to delay application of the scan signal to the subsequent scan electrodes by a predetermined time after the non-scan signal is applied to a current scan electrode.

The scan driver may be configured to apply the scan signal to the subsequent scan electrode simultaneously with the address signal returning to the base state.

The scan driver may be configured to apply the non-scan voltage to all scan electrodes while application of the address signal is completed.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates driving waveforms for a plasma display panel including an address energy recovery circuit (AERC);

FIG. 2A illustrates a detailed view of a portion of an address period shown in FIG. 1;

FIG. 2B illustrates actual measured waveforms corresponding to the portion in FIG. 2A;

FIG. 3 illustrates driving waveforms for a plasma display panel according to an exemplary embodiment;

FIG. 4A illustrates a detailed view of a portion of an address period shown in FIG. 3;

FIG. 4B illustrates actual measured waveforms corresponding to the portion in FIG. 4A; and

FIG. 5 illustrates a block diagram of a plasma display panel including a driver configured to drive the plasma display panel in accordance with embodiments.

### DETAILED DESCRIPTION OF PREFERRED EMBODIMENTS

Korean Patent Application No. 10-2008-0073541, filed on Jul. 28, 2008, in the Korean Intellectual Property Office, and entitled “Method of Driving Plasma Display Panel,” is incorporated by reference herein in its entirety.

Hereinafter, certain exemplary embodiments according to the present invention will be described with reference to the accompanying drawings. Here, when a first element is described as being coupled to a second element, the first element may be not only directly coupled to the second element but may also be indirectly coupled to the second element via a third element. Further, some of the elements that are not essential to the complete understanding of the invention are omitted for clarity. Also, like reference numerals refer to like elements throughout.

In addition, “wall charges” described herein mean charges formed and accumulated on a wall, e.g., a dielectric layer, close to an electrode of a discharge cell. A wall charge may be described as being “formed on” or “accumulated on” the electrode, although the wall charges may not actually touch the electrode. Further, a “wall voltage” means a potential difference formed on the wall of the discharge cell by the wall charge.

Prior to description of exemplary embodiments, a method of driving a plasma display panel will be described in detail. In this case, the plasma display panel is provided with an address energy recovery circuit (hereinafter, referred to as “AERC”) in order to reduce the increase in address power consumption. Use of an AERC may be of particular interest in higher resolution panels. In particular, higher resolution panels may have more compact discharge cells, resulting in shorter gaps between the electrodes. Also, as the size of the discharge cells decreases, the address power consumption increases.

FIG. 1 illustrates driving waveforms for a plasma display panel having an AERC. For convenience, one subfield period is described as an illustrative example of the driving method. As shown in FIG. 1, according to the method of driving the plasma display panel, each subfield may include a reset period (Pr), an address period (Pa), and a sustain period (Ps).

During the reset period (Pr), cells may be initialized to remove the wall charges formed in the previous sustain discharge and stably perform the next address discharge. During the address period (Pa), cells to be turned or not turned on in a panel may be selected and wall charges may be accumulated in the turned-on cells (addressed cells). During the sustain period (Ps), a sustain discharge operation during which images are displayed in the addressed cell may be performed.

During the address period (Pa), the sustain electrodes (X) may be maintained at a constant voltage, and scan pulses and address pulses may be applied to the scan electrodes (Y) and the address electrodes (A) in a cell to be displayed during the address period (Pa). In the particular example illustrated in FIG. 1, the scan pulse may select a scan electrode (Y1) by applying a low scan voltage (VscL) to the scan electrodes (Y1) to be selected, while other scan electrodes (Y2) may be maintained at a high scan voltage (VscH). The address pulse is a pulse for applying an address voltage (Va) to an address electrode (A) in a cell to be selected among the cells formed by the scan electrodes (Y1 ) to which the low scan voltage (VscL) is applied. Address discharge is achieved by the difference between the address voltage (Va) applied to the address electrode (A) and the low scan (VscL) applied to the scan electrodes (Y1). Once the scan pulse applied to the selected scan electrodes (Y1) returns to the high scan voltage (VscH), the low scan voltage (VscL) is applied to subsequent scan electrodes (Y2).

As described above, since discharge spaces between the scan electrode and the sustain electrode, and between a surface on which the address electrode is formed and a surface on which the scan and sustain electrodes are formed, acts as a capacitive load (a ‘panel capacitor’), capacitances are present in the panel. Therefore, in addition to power required for the addressing voltage, a plurality of charge-injecting reactive powers for generating a predetermined voltage in the capacitance are required to apply an addressing waveform, which leads to the increase in address power consumption.

Further, as the resolution of the panel increases, a gap between the electrodes may decrease and the number of the discharge cells may increase. Also, as the discharge cells decrease in size, the address power consumption is increased.

Such high power consumption may increase loads on an address driver, increasing heat generation and causing damage to the address driver. In order to solve the above problems, the address driver may include an energy recovery circuit, e.g., an address energy recovery circuit (hereinafter, referred to as an ‘AERC’), for recovering and re-using reactive power.

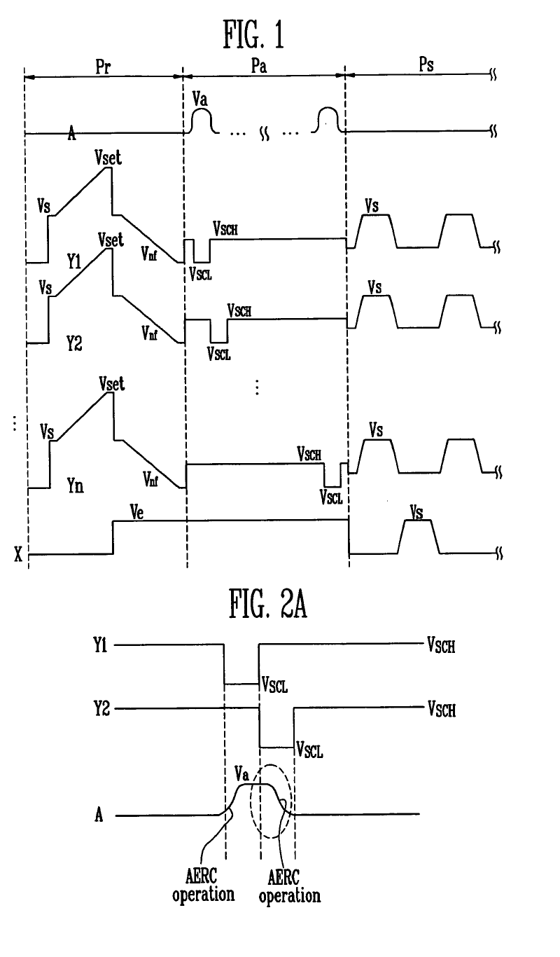

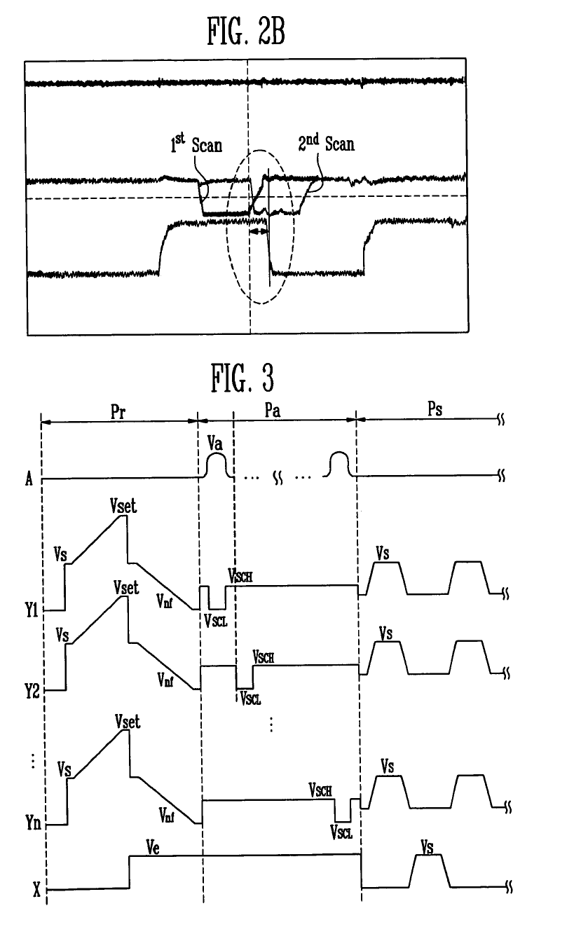

The AERC is a circuit that recovers and re-uses reactive power by using an inductor electrically coupled to an address electrode and resonance of the capacitive load. The AERC reduces hard switching using the resonance, as can be seen from the shape of the address pulses in FIG. 1. However, the AERC having such a waveform may not complete application of the address pulse while the corresponding scan electrode is selected, i.e., the address pulse may not return to a base level before the scan signal returns to the scan high voltage (VscH). Therefore, discharge in the selected discharge cells may be reduced, as described in connection with FIGS. 2A and 2B.

FIG. 2A illustrates a detailed view of a portion of the address period shown in FIG. 1. FIG. 2B illustrates actual measured waveforms corresponding to the detailed view in FIG. 2A.

Referring to FIG. 2A and FIG. 2B, the waveform of the address signal or pulse output by the AERC has a period that is greater than a period during which the address voltage (Va) is applied due to the LC resonance. This LC resonance is evident during a period that the waveform applied to the address electrode increases or decreases, i.e., before and after a steady state of applying the address voltage (Va). Therefore, since the address voltage Va is only applied to the address electrode after the LC resonance, the application of the address voltage Va may be delayed by as much as the resonance time, i.e., a waveform-increasing period, thus delaying formation of address discharge.

In contrast, the low scan voltage (VSCL) is sequentially applied to the scan electrodes to which a scan pulse is applied, as described above. That is to say, the second scan electrodes (Y2) are scanned, i.e., receive the low scan voltage VSCL, immediately after the first scan electrodes (Y1) are scanned, as illustrated in FIG. 2A and FIG. 2B.

However, the scan waveform does not have LC resonance, i.e., does not have the shape of the waveform applied to the address electrode before and after the application of the address voltage (Va), as described above. In other words, a period of the scan pulse is substantially equal to a period during which the low scan voltage (VscL) is applied. The period during which the low scan voltage (VscL) is applied to selected scan electrodes corresponds to a period during which the address voltage (Va) is applied. Due to the LC resonance of the address signal, application periods of the address voltage (Va) and the low scan voltage (VscL) for a selected cell do not completely overlap. Therefore, address discharge may not easily occur in the selected cells, i.e., the cell selected in the first scan electrodes (Y1), since some data are substantially transferred from the selected cells in the first or current scan electrodes (Y1) to the discharge cells selected in the second or subsequent scan electrodes (Y2), which leads to low discharge.

Embodiments are directed to solving the above problems. In accordance with embodiments, the plasma display panel may be driven using the AERC while delaying subsequent sequential application of scan pulses to the scan electrodes, e.g. by as much as a predetermined delayed time gap. In other words, a delayed time gap before a subsequent scan pulse, e.g., the low scan voltage (VscL), is applied may be determined in accordance with an effect of the LC resonance on the address pulse, such that addressing may be completed before application of the scan pulse to the next scan electrode.

Hereinafter, exemplary embodiments will be described in more detail with reference to the accompanying drawings. FIG. 3 illustrates driving waveforms for a plasma display panel according to one exemplary embodiment. Here, for convenience, one subfield period is described. Referring to FIG. 3, each subfield may be divided into a reset period (Pr), an address period (Pa), and a sustain period (Ps) in accordance with an exemplary embodiment.

When a scan operation is performed by applying the low level scan voltage (VscL) to the scan electrodes (Y1) to select discharge cells to be displayed among the discharge cells during the address period, the address voltage (Va) may be applied to the address electrodes (A) via the AERC. Then, the cells selected during the address period may be discharged during the sustain period by alternately applying a sustain voltage (Vs) to the scan electrodes (Y) and the sustain electrodes (X) in order to display a grey level of the plasma display panel.

As previously described in FIG. 2A and FIG. 2B, the conventional plasma display panel has an LC resonance waveform before/after the application of the address voltage (Va), i.e., has a waveform due to the LC resonance during a period in which the address signal increases to or decreases from the address voltage (Va), while there are no such corresponding periods in the scan signal. Therefore, the conventional plasma display panel has a problem that the address discharge does not easily occur in the substantially selected discharge cells, i.e., discharge cells selected by the first scan electrodes, since some data are transferred from the discharge cells selected by the first scan electrodes (Y1) to the discharge cells selected by the second scan electrodes (Y2), resulting in low discharge.

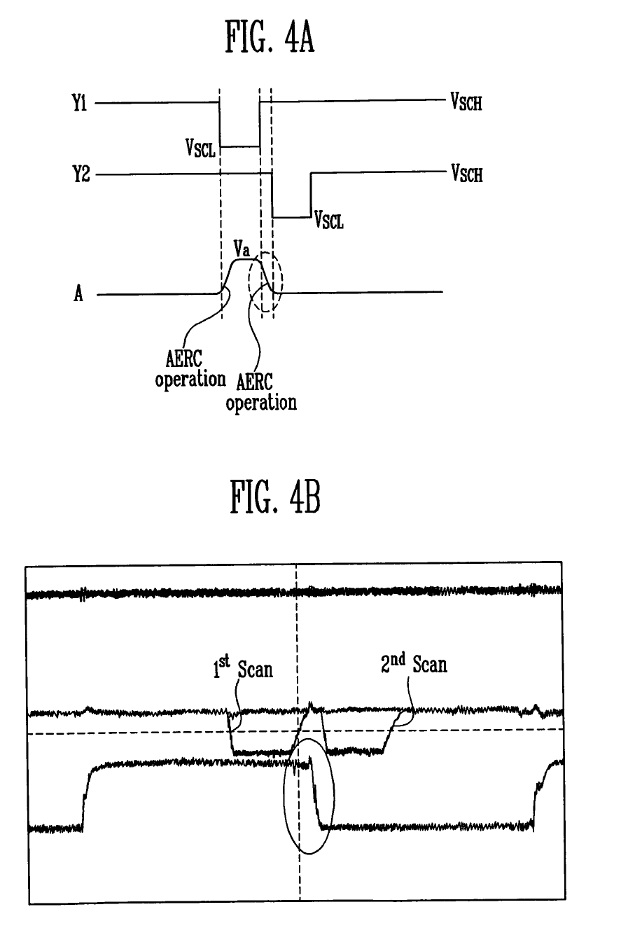

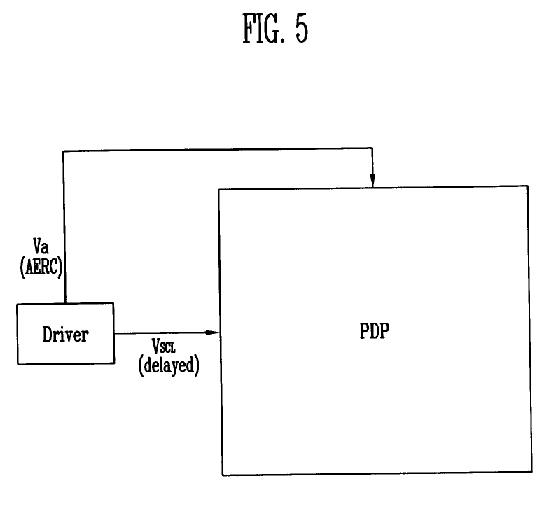

In order to solve the above problems, the plasma display panel according to an exemplary embodiment may delay application of the scan pulse to next scan electrodes by as much as a predetermined delayed time gap, i.e., a delayed time gap considering an effect on the LC resonance of the address pulse, as shown in FIG. 3. This is described in detail with reference to FIGS. 4a and 4B.

FIG. 4A illustrates a detailed view of a portion of an address period in a driving method of the plasma display panel according to one exemplary embodiment as shown in FIG. 3. FIG. 4B illustrates a measured waveform generated using the waveform of FIG. 4A.

Referring to FIG. 4A and FIG. 4B, in order to solve the problems regarding the LC resonance waveform before/after the application of the address voltage (Va) generated in driving the AERC, an exemplary embodiment may delay sequential application of the scan pulse to subsequent scan electrodes by as much as a predetermined delayed time gap, e.g., a time gap determined considering an effect on the LC resonance of the address pulse.

In the conventional plasma display panel, the second scan electrodes (Y2) are scanned right after the first scan electrodes (Y1) are scanned, as shown in FIG. 2A. In contrast, in the plasma display panel according to an exemplary embodiment, the second scan electrodes (Y2) are not scanned right after the first scan electrodes (Y1) are scanned. Rather, scanning of the second scan electrodes (Y2) may be delayed by as much as a period that the address waveform is extended by use of the AERC, as illustrated in FIG. 4A.

As a result, according to the driving method of an exemplary embodiment, when the AERC is used during the address period to perform an addressing operation, a data signal, i.e., an address waveform formed by the AERC, may be applied in its entirety to the selected cell.

Then, the low scan voltage (VscL) may be sequentially to the second scan electrodes (Y2) when the application of the address pulse is completed, i.e., returns to a base level, in consideration of the address waveform being extended during a predetermined period after the Va voltage is applied by the LC resonance.

That is to say, when the low scan voltage (VscL) is applied to the second scan electrodes (Y2) after the low scan voltage (VscL) is applied to the first scan electrodes (Y1), a predetermined time gap between the applications of the low scan voltages may be maintained in consideration of the effect of the LC resonance of the address waveform. In this case, the high scan voltage (VscH) voltage may be applied during the time gap, i.e., the high scan voltage (VscH) may be applied to all scan electrodes between sequential scans.

FIG. 5 illustrates a block diagram of a driver outputting an address voltage using an AERC to address electrodes of a plasma display panel (PDP) and a delayed low scan voltage (VscL) to scan electrodes of the PDP in accordance with an embodiment.

Through the above-mentioned driving method, the use of the AERC driving method, and a driver employing the same, may reduce low discharge of the address electrodes in the substantially selected discharge cells. While particular pulses have been illustrated herein, it is to be understood that it is the voltage difference that is of interest, and various different waveforms may be used with embodiments. Further, while the high scan voltage (VscH) has been illustrated as being applied to the scan electrodes during the delay period, any voltage that reduces the voltage difference between the voltage applied to the address electrodes and the scan electrodes may be used. Additionally, instead of the delay between application of scan signals, the period of the scan signal, i.e., an application period of the low scan voltage (VscL), may be increased in accordance with an actual period of the address signal. Finally, rather than starting when the address signal returns to a base level, application of the scan signal may be delayed until the voltage applied to the address electrodes reaches a certain threshold when increasing up to the address voltage (Va).

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A method of driving a plasma display panel having a capacitive load formed by a plurality of scan electrodes and a plurality of address electrodes crossing the scan electrodes, using a driver including an address energy recovery circuit (AERC) that applies an address voltage to the address electrodes by an inductor electrically coupled to the address electrodes and resonance of the capacitive load, wherein, during an address period in which one of a scan signal and a non-scan signal is applied to each of the scan electrodes, the method comprising:
applying the scan signal to a current scan electrode; and
applying the scan signal to a subsequent scan electrode adjacent the current scan electrode after application of an address signal is complete, the address signal differs from a base state for a period longer than application of the address voltage.

2. The method of driving a plasma display panel as claimed in claim 1, wherein the address signal has an LC resonance waveform before/after applying the address voltage (Va).

3. The method of driving a plasma display panel as claimed in claim 2, wherein applying the address signal is complete when the LC resonance waveform is completed after the application of the address voltage.

4. The method of driving a plasma display panel as claimed in claim 1, further comprising applying the non-scan signal to the subsequent scan electrode from when the scan signal is applied to the current scan electrode to when the scan signal is applied to the subsequent scan electrode.

5. The method of driving a plasma display panel as claimed in claim 1, wherein applying the scan signal to the subsequent scan electrode is delayed by a predetermined time after the non-scan signal is applied to the current scan electrode.

6. The method of driving a plasma display panel as claimed in claim 1, wherein applying the scan signal to the subsequent scan electrode is concurrent with the address signal returning to the base state.

7. The method of driving a plasma display panel as claimed in claim 1, further comprising applying the non-scan voltage to all scan electrodes while completing application of the address signal.

8. A driver for use with a plasma display panel having a capacitive load formed by a plurality of scan electrodes and a plurality of address electrodes crossing the scan electrodes, the driver comprising:
an address energy recovery circuit (AERC) configured to generate an address signal including an address voltage to be applied to the address electrodes by an inductor electrically coupled to the address electrodes and resonance of the capacitive load, a period during which the address signal is different from a base state being longer than a period during which the address voltage is applied; and
a scan driver configured to apply, during an address period, one of a scan signal and a non-scan signal to each of the scan electrodes, the scan driver being configured to apply the scan signal to a subsequent scan electrode when application of the address signal to a current cell is complete.

9. The driver as claimed in claim 8, wherein the address signal has an LC resonance waveform before/after applying the address voltage (Va).

10. The driver as claimed in claim 9, wherein applying the address signal is complete when the LC resonance waveform is completed after the application of the address voltage.

11. The driver as claimed in claim 8, wherein the scan driver is configured to apply the non-scan signal to the subsequent scan electrode from when the scan signal is applied to a current scan electrode to when the scan signal is applied to the subsequent scan electrode.

12. The driver as claimed in claim 8, wherein the scan driver is configured to delay application of the scan signal to the subsequent scan electrodes by a predetermined time after the non-scan signal is applied to a current scan electrode.

13. The driver as claimed in claim 8, wherein the scan driver is configured to apply the scan signal to the subsequent scan electrode simultaneously with the address signal returning to the base state.

14. The driver as claimed in claim 8, wherein the scan driver is configured to apply the non-scan voltage to all scan electrodes while application of the address signal is completed.
